(19) United States
(12) Patent Application Publication
(10) Pub. No.: US 2006/0238054 A1
(43) Pub. Date: Oct. 26, 2006

(54) MAGNET RETAINER CLIP FOR PERMANENT MAGNET ELECTRIC MOTORS

(75) Inventors: Liqin Wang, Naperville, IL (US); George Thomas, Lombard, IL (US); Eric Vallejo, Schaumburg, IL (US)

Correspondence Address: VEDDER PRICE KAUFMAN & KAMMHOLZ, 222 N. LASALLE STREET, CHICAGO, IL, 60601, US

(73) Assignee: BISON GEAR & ENGINEERING CORP., St. Charles, IL (US)

(21) Appl. No.: 10/908,051

(22) Filed: Apr. 26, 2005

(51) Int. Cl. H02K 23/04

(52) U.S. Cl. 310/154.16

(57) ABSTRACT

A clip for a motor stator housing to engage at least a first magnet and at least a second magnet of the motor stator includes a generally annular plate having an outer circumferential edge and an inner side. A plurality of outer tabs are radially arranged on the outer circumferential edge and extend outward relative to the outer circumferential edge, wherein the outer tabs engage an inner surface of the stator housing. At least a pair of first inner tabs extend outward from the inner side of the annular plate and are configured to engage opposing sidewalls of the first magnet. At least a pair of second inner tabs extend outward from the inner side of the annular plate and are configured to engage opposing sidewalls of the second magnet.

### FIELD OF THE DISCLOSURE

The present disclosure generally relates to electric motors, and more particularly, to a magnet retainer clip for permanent magnet electric motors.

### BACKGROUND

Permanent magnet electric motors typically have a number of permanent magnets that are attached to an inner surface of the motor housing to form a stator. The magnets are typically attached to the inner surface by an adhesive rather than by fasteners in order to reduce production and assembly costs. A drawback to using adhesive is that after prolonged use of the motor, the adhesive may degrade and cause the permanent magnets to become detached from the motor housing, thus rendering the motor inoperable.

Various prior art solutions exist for maintaining the permanent magnets in the motor housing in the proper position for operation of the motor. These solutions typically involve a ring-type retainer that includes a number of tabs that press the permanent magnets against the inner surface of the motor housing. However, such ring-type retainers are only for use in a particular motor for which the retainer was designed. Accordingly, such ring-type retainers cannot be used in permanent magnet motors with differing structural designs. In particular, the methods and structures by which the ring-type retainer is supported in the motor housing differs greatly and depends upon the internal structure of the motor housing. Additionally, such ring-type retainers require a particular assembly method to secure the ring-type retainer in the motor for which it is designed.

Therefore, there exists a need for a ring-type retainer that can be simply mounted in a motor housing, can secure itself inside the motor housing, is able to retain the permanent magnets in the motor housing in the proper position for the operation of the motor, and has a design so as to be compatible for use in a variety of permanent magnet motors.

### BRIEF DESCRIPTION OF THE DRAWINGS

Certain embodiments are shown in the drawings. However, it is understood that the present disclosure is not limited to the arrangements and instrumentality shown in the attached drawings, wherein:

FIG. 1 illustrates a perspective view of an electric motor;

FIG. 2 illustrates an exploded view of the motor of FIG. 1;

FIG. 3 illustrates a perspective view of a clip constructed in accordance with the teachings of the present disclosure showing an outer side of the clip;

FIG. 4 illustrates a perspective fragmentary view of a motor stator having therein the clip of FIG. 3; and

FIG. 5 illustrates a perspective view of the clip of FIG. 3 showing an inner side of the clip.

### DETAILED DESCRIPTION

For the purposes of promoting and understanding the principles disclosed herein, reference will now be made to the preferred embodiments illustrated in the drawings and specific language will be used to describe the same. It will nevertheless be understood that no limitation of the scope is thereby intended. Such alterations and further modifications in the illustrated device and such further applications are the principles disclosed as illustrated therein as being contemplated as would normally occur to one skilled in the art to which this disclosure relates.

In accordance with one principal aspect of the present disclosure, a clip for a motor stator housing to engage at least a first magnet and at least a second magnet of the motor stator includes a generally annular plate having an outer circumferential edge and an inner side. A plurality of outer tabs are radially arranged on the outer circumferential edge and extend outward relative to the outer circumferential edge, wherein the outer tabs engage an inner surface of the stator housing. At least a pair of first inner tabs extend outward from the inner side of the annular plate and are configured to engage opposing sidewalls of the first magnet. At least a pair of second inner tabs extend outward from the inner side of the annular plate and are configured to engage opposing sidewalls of the second magnet.

In accordance with another principal aspect of the present disclosure, an electric motor includes a hollow motor stator housing having a generally cylindrical inner surface, at least a first arcuate magnet mounted on a first longitudinal portion of the inner surface of the stator housing, and at least a second arcuate magnet mounted on a second longitudinal portion of the inner surface of the stator housing. The electric motor further includes a pair of clips with each clip mounted in the stator housing proximate to ends of the first magnet and the second magnet. Each clip includes a generally annular plate having an outer circumferential edge and an inner side, a plurality of outer tabs radially arranged on the outer circumferential edge and extending outward relative to the outer circumferential edge, at least a pair of first inner tabs extending outward from the inner side of the annular plate and configured to engage opposing sidewalls of the first magnet, and at least a pair of second inner tabs extending outward from the inner side of the annular plate and configured to engage opposing sidewalls of the second magnet. The outer tabs of the clips engage the inner surface of the stator housing to maintain the clips mounted in the stator housing. Additionally, the pair of first inner tabs of the pair of clips engage the sidewalls of the first magnet to maintain the first magnet mounted to the first longitudinal portion of the inner surface of the stator housing. Additionally, the pair of second inner tabs of the pair of clips engage the sidewalls of the second magnet to maintain the second magnet mounted to the second longitudinal portion of the inner surface of the stator housing.

In accordance with another principal aspect of the present disclosure, a clip for a motor stator housing to engage at least a first magnet and at least a second magnet of the motor stator includes at least a first arcuate portion configured to correspond to the first magnet, the first arcuate portion including a pair of first inner tabs extending toward the first magnet and engaging sidewalls of the first magnet when the first arcuate portion is mounted in the stator housing adjacent an end of the first magnet, and at least a second arcuate portion configured to correspond to the second magnet, the second arcuate portion including a pair of second inner tabs extending toward the second magnet and engaging sidewalls of the second magnet when the second arcuate portion is disposed mounted in the stator housing adjacent an end of the second magnet. The clip further includes a plurality of outer tabs radially arranged on outer edges of the first arcuate portion and the second arcuate portion, the outer tabs extending outward relative to the outer outer edges, wherein the outer tabs engage an inner surface of the stator housing to maintain the first arcuate portion and the second arcuate portion mounted in the stator housing. The clip additionally includes a pair of connecting portions configured to connect the first arcuate portion and the second arcuate portion.

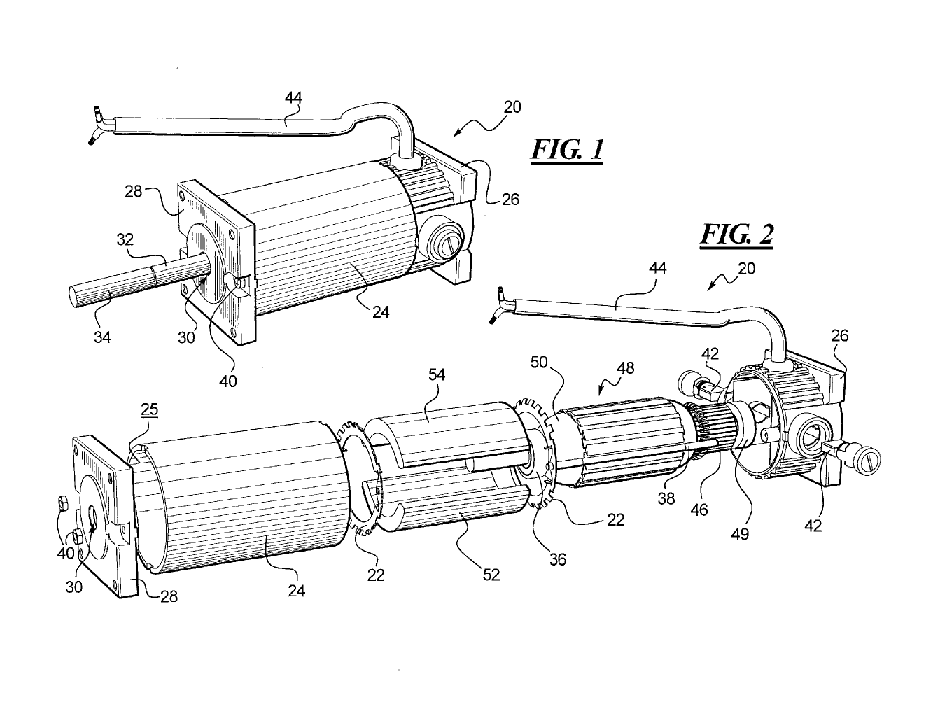

Referring to FIGS. 1 and 2, an electric motor 20 having a pair of retainer clips 22 constructed in accordance with the teachings of the present disclosure is shown. The electric motor includes a stator housing 24 having a generally cylindircal inner surface 25. The stator housing 24 is enclosed at both ends by an end cap 26 and a faceplate 28. The faceplate 28 includes a bore 30, through which a rotor shaft 32 extends outside the stator housing 24 and the faceplate 28. The rotor shaft 32 may also include a rotor shaft extension 34. Between the rotor shaft 32 and the bore 30 a bearing 36 may be disposed to provide free rotation of the rotor shaft 32 relative to the faceplate 28. As shown in FIG. 2, the faceplate 28, the stator housing 24 and the end cap 26 are connected and secured together by a pair of tie rods 38. The tie rods 38 are attached to the end housing 26 and extend through the stator housing and the faceplate 28. The tie rods 38 are then secured by tie rod fasteners 40.

The electric motor 20 includes a pair of brushes 42 that receive power from a power cord 44 and transfer the power to a commutator 46 of a rotor 48. The rotor 48 is rotationally mounted to the end cap 26 with a bearing 49, which is disposed between the end of the rotor 48 and the end housing 26. The rotor 48 includes the commutator 46 and wire windings 50 that are disposed on and surround the rotor shaft 32. The rotor 48 extends longitudinally through the stator housing 24 such that it defines a longitudinal axis of the stator housing 24. Also disposed in the stator housing 24 is a pair of magnets, which are herein referred to as the first magnet 52 and the second magnet 54. The first magnet 52 and the second magnet 54 are arcuate such that the outer surfaces thereof match the shape of the inner surface 25 of the stator housing 24. The first magnet 52 and the second magnet 54 are typically attached to the inner surface 25 of the stator housing 24 by an adhesive (not shown). However, the pair of clips 22 can be used instead of any type of adhesive to attach the first magnet 52 and the second magnet 54 to the inner surface 25 of the stator housing 24. Additionally, both an adhesive and the pair of clips 22 can be used to maintain the magnets 52 and 54 attached to the inner surface 25 of the stator housing 24. When both the adhesive and the pair of clips 22 are used, the clips 22 can maintain the magnets 52 and 54 attached to the inner surface 25 of the stator housing 24 should the adhesive degrade so as to fail.

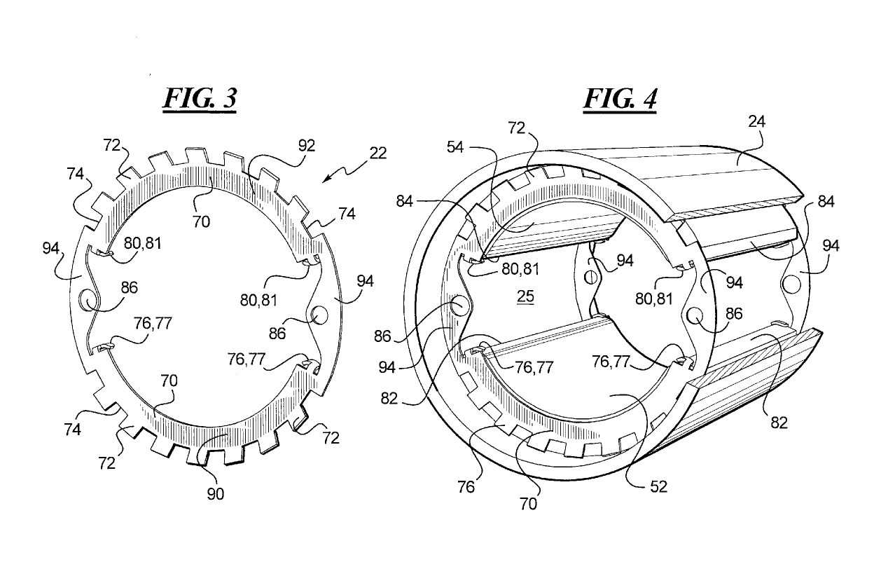

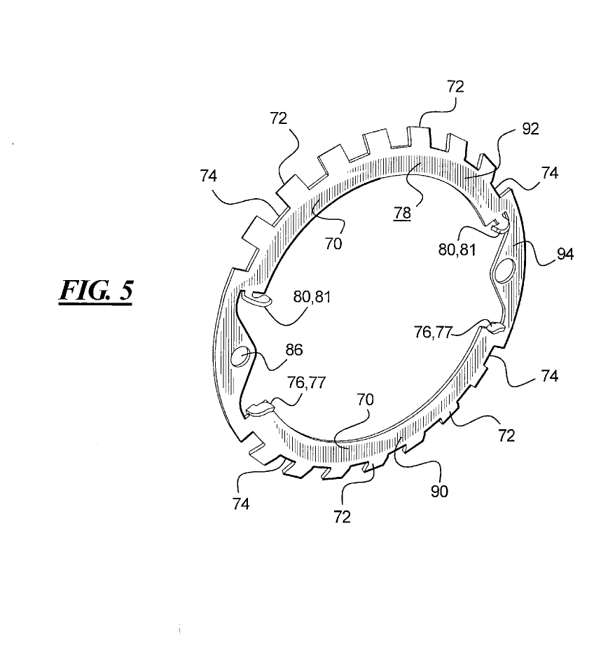

Referring to FIG. 3 and FIG. 5, the clip 22 includes a generally annular plate 70 and a plurality of outer tabs 72 that are radially arranged on an outer circumferential edge 74 of the annular plate 70. The clip 22 further includes a pair of first inner tabs 76 that extend outward from an inner side 78 of the annular plate 70 and a pair of second inner tabs 80 that extend outward from the inner side 78 of the annular plate 70. Referring to FIG. 4, when the annular plate 70 is disposed in the stator housing 24 such that it abuts the end of the first magnet 52 and the second magnet 54, the outer tabs 72 engage the inner surface 25 to securely maintain annular plate 70 in the stator housing 24. Additionally, the first inner tabs 76 engage opposing sidewalls 82 of the first magnet 52 to maintain the magnet attached to the inner surface 25 of the stator housing 24. Similarly the second inner tabs 80 engage opposing sidewalls 84 of the second magnet 54 to maintain the second magnet 54 attached to the innerside 25 of the stator housing 24. The annular plate 70 also includes a pair of apertures 86 that are configured to allow the tie rods 38 to pass through the stator housing 24 as described above.

Referring to FIGS. 3-5, the clip 22 will now be described in more detail. The clip 22 includes a first arcuate portion 90 and a second arcuate portion 92 that are connected by a pair of connecting portions 94, all of which generally define the above described annular plate 70. The first inner tabs 76 are disposed proximate to the opposing ends of the first arcuate portion 90 and extend outward relative to the inner side 78 of the first arcuate portion 90. Similarly, the second inner tabs 80 are disposed proximate to the opposing ends of the second arcuate portion 92 and extend outward from the inner side 78 of the second arcuate portion 92. The first arcuate portion 90 is configured to correspond to the shape of the end of the first magnet 52 such that when the annular plate 70 is positioned over the first magnet 52 and the second magnet 54, the first inner tabs 76 engage the opposing sidewalls 82 of the first magnet 52. Similarly, the second arcuate portion 92 is configured to correspond to the end of the second magnet 54 such that when the annular plate 70 is placed over the first magnet 52 and the second magnet 54, the second inner tabs 80 engage the opposing sidewalls 84 of the second magnet 54. The connecting portions 94 connect the first arcuate portion 90 and the second arcuate portion 92 and further include the apertures 86 through which the tie rods 38 can pass. Each of the first arcuate portion 90 and the second arcuate portion 92 includes the plurality of the outer tabs 72 that engage the inner surface 25 of the stator housing 24 when the annular plate 70 is placed over the magnets 52 and 54.

Referring to FIG. 4, the clip 22 may be constructed from a thin metal plate to provide the annular plate 70 with resilient flexibility. When the clip 22 is engaged with the inner surface 25 of the stator housing 24, the outer tabs 72 press against the inner surface 25. Accordingly, the pressing engagement of the outer tabs 72 with the inner surface 25 may flex the outer tabs 72 and/or the annular plate 70. However, the resilient flexibility of the outer tabs 72 and/or the annular plate 70 causes outward biasing of the outer tabs 72 such that the outer tabs 72 more strongly engage the inner surface 25. Therefore, the resilient flexibility of the outer tabs 72 and/or the annular plate 70 and the engagement of the outer tabs 72 with the inner surface 25 of the stator housing 24 securely maintain the clip 22 in of the stator housing 24.

As shown in FIGS. 3-5, the first inner tabs 76 and the second inner tabs 80 include bent or hooked ends 77 and 81, respectively. As shown in FIG. 4, the ends 77 and 81 complementarily fit and engage the sidewalls 82 and 84 of the first magnet 52 and the second magnet 54, respectively. The ends 77 and 81 restrain the magnets 52 and 54 from separating from the inner surface 25 of the stator housing 24. Additionally, the bent or hooked shape of the ends 77 and 81 prevents the magnets 52 and 54 from any side to side or lateral movement relative to the inner surface 25. Furthermore, the first inner tabs 76 and the second inner tabs 80 are also resiliently flexible to provide the tight fit when engaged with the sidewalls 82 and 84, respectively. Therefore, the inner tabs 76 and 80 maintain the magnets 52 and 54 attached to the inner surface 25 of the stator housing 24 in the proper position for the operation of the motor 20.

The clip 22 can be manufactured from a single metal plate. For example, the clip 22 can be cut from a sheet of steel by first cutting the general shape of the annular plate 70. The cutting can be performed by physically cutting the sheet of steel or by a stamping process. After the general shape of the annular plate 70 is cut out of the steel sheet, the outline of the outer tabs 72, the first inner tab 76 and the second inner tabs 80 can be cut out or stamped out of the general shape of the annular plate 70. Thereafter, the connecting portions 94 of the clip 22 can be cut to shape or stamped. In this state, the clip 22 has been substantially formed except that all the above described components are in a single plane or are flat. Accordingly, the final step may be to bend the first inner tabs so that they extend outward relative to the inner side 78 of the clip 22 and to slightly bend the outer tabs 72 upward so that they are positioned for a desired level of engagement with the inner surface 25 of the stator housing 24.

As described above, a clip 22 can be constructed from a single metal plate. The metal used for the clip 22 may be corrosion resistant so as to maintain its function in a variety of environments in which the motor 20 is used. Additionally, the metal plate should be constructed from a material that can provide the above-described resilient flexibility. However, the clip 22 can be constructed from any material that provides the above described functions to maintain the magnets 52 and 54 in the stator housing 24 during the operation of the motor 20. The clip 22 can be configured to provide the above described functions for any motor having any number of magnets. In the disclosed examples, the motor 20 includes two magnets, namely the first magnet 52 and the second magnet 54.

However, one of ordinary skill in the art will appreciate that certain electric motors may include more than two magnets. Accordingly, the clip 22 can be designed to include any desired member of inner tabs to correspond with the number of magnets that are mounted in the stator housing 24. Additionally the first arcuate portion 90, the second arcuate portion 92 and the connection portions 94 can be sized, arranged and configured so as to correspond with an inner surface of any stator housing 24 for which the clip 22 is designed. Furthermore, one of ordinary skill in the art will appreciate that the clip 22 can be manufactured separately and can be added to pre-existing motors by disassembling the motor and adding the clips 22 to the ends of the magnets and the motor as fully described above.

Furthermore, while the particular preferred embodiments have been shown and described, it will be obvious to those skilled in the art that changes and modifications may be made without departing from the teaching of the disclosure. The matter set forth in the foregoing description and accompanying drawings is offered by way of illustration only and not as limitation. The actual scope of the disclosure is intended to be defined in the following claims when viewed in their proper perspective based on the related art.

What is claimed is:

1. A clip for a motor stator housing to engage at least a first magnet and at least a second magnet of the motor stator, the clip comprising:
a generally annular plate having an outer circumferential edge and an inner side;
a plurality of outer tabs radially arranged on the outer circumferential edge and extending outward relative to the outer circumferential edge, wherein the outer tabs engage an inner surface of the stator housing;
at least a pair of first inner tabs extending outward from the inner side of the annular plate and configured to engage opposing sidewalls of the first magnet; and
at least a pair of second inner tabs extending outward from the inner side of the annular plate and configured to engage opposing sidewalls of the second magnet.

2. The clip of claim 1, wherein the pair of first inner tabs include hooked ends to maintain the first magnet mounted to a first longitudinal portion of the inner surface of the stator housing, and wherein the pair of second inner tabs include hooked ends to maintain the second magnet mounted to a second longitudinal portion of the inner surface of the stator housing, and wherein the second longitudinal portion is laterally opposed to the first longitudinal portion.

3. The clip of claim 1, wherein the first inner tabs are resiliently flexible to engage the side walls of the first magnet and the second inner tabs are resiliently flexible to engage the sidewalls of the second magnet.

4. The clip of claim 1, wherein the outer tabs are resiliently flexible to maintain a position of the annular plate in the motor stator.

5. The clip of claim 1, wherein the annular plate further comprises a pair of opposing apertures to provide pass through of motor tie rods.

6. The clip of claim 1, wherein the annular plate, the outer tabs and the first and second inner tabs are all integrally constructed from a single metal plate.

7. An electric motor comprising:
a hollow motor stator housing having a generally cylindrical inner surface; at least a first arcuate magnet mounted on a first longitudinal portion of the inner surface of the stator housing;
at least a second arcuate magnet mounted on a second longitudinal portion of the inner surface of the stator housing;
a pair of clips, each clip mounted in the stator housing proximate to ends of the first magnet and the second magnet, each clip comprising:
a generally annular plate having an outer circumferential edge and an inner side;
a plurality of outer tabs radially arranged on the outer circumferential edge and extending outward relative to the outer circumferential edge;
at least a pair of first inner tabs extending outward from the inner side of the annular plate and configured to engage opposing sidewalls of the first magnet; and
at least a pair of second inner tabs extending outward from the inner side of the annular plate and configured to engage opposing sidewalls of the second magnet;
wherein the outer tabs of the clips engage the inner surface of the stator housing to maintain the clips mounted in the stator housing;
wherein the pair of first inner tabs of the pair of clips engage the sidewalls of the first magnet to maintain the first magnet mounted to the first longitudinal portion of the inner surface of the stator housing; and
wherein the pair of second inner tabs of the pair of clips engage the sidewalls of the second magnet to maintain the second magnet mounted to the second longitudinal portion of the inner surface of the stator housing.

8. The electric motor of claim 7, wherein the pair of first inner tabs include hooked ends that engage the sidewalls of the first magnet, and wherein the pair of second inner tabs include hooked ends that engage the sidewalls of the second magnet.

9. The electric motor of claim 7, wherein the annular plate of each clip is constructed from a thin metal such that the annular plate is resiliently flexible.

10. The electric motor of claim 7, wherein the first inner tabs are resiliently flexible to engage the side walls of the first magnet and the second inner tabs are resiliently flexible to engage the sidewalls of the second magnet.

11. The electric motor of claim 7, wherein the outer tabs are resiliently flexible to maintain a position of the annular plate in the motor stator.

12. The electric motor of claim 7, wherein the annular plate of each clip further comprises a pair of opposing apertures to provide pass through of motor tie rods through the pair of clips.

13. The electric motor of claim 7, wherein the annular plate, the outer tabs and the first and second inner tabs of each clip are all integrally constructed from a single metal plate.

14. A clip for a motor stator housing to engage at least a first magnet and at least a second magnet of the motor stator, the clip comprising:
at least a first arcuate portion configured to correspond to the first magnet, the first arcuate portion including a pair of first inner tabs extending toward the first magnet and engaging sidewalls of the first magnet when the first arcuate portion is mounted in the stator housing adjacent an end of the first magnet;
at least a second arcuate portion configured to correspond to the second magnet, the second arcuate portion including a pair of second inner tabs extending toward the second magnet and engaging sidewalls of the second magnet when the second arcuate portion is disposed mounted in the stator housing an end of the second magnet;
a plurality of outer tabs radially arranged on outer edges of the first arcuate portion and the second arcuate portion, the outer tabs extending outward relative to the outer outer edges, wherein the outer tabs engage an inner surface of the stator housing to maintain the first arcuate portion and the second arcuate portion mounted in the stator housing; and
a pair of connecting portions configured to connect the first arcuate portion and the second arcuate portion.

15. The clip of claim 14, wherein the pair of first inner tabs include hooked ends that engage the sidewalls of the first magnet, and wherein the pair of second inner tabs include hooked ends that engage the sidewalls of the second magnet.

16. The clip of claim 14, wherein the first inner tabs are resiliently flexible to engage the side walls of the first magnet and the second inner tabs are resiliently flexible to engage the sidewalls of the second magnet.

17. The clip of claim 14, wherein the first and second arcuate portions are constructed from a thin metal such that the first and second arcuate portions are resiliently flexible.

18. The clip of claim 14, wherein when the outer tabs are resiliently flexible to securely engage the inner surface of the stator housing.

19. The clip of claim 14, wherein each connecting portion further comprises an aperture to provide pass through of a motor tie rod.

20. The clip of claim 14, wherein the first arcuate portion, the second arcuate portion, the outer tabs, the first and second inner tabs, and the connecting portions are all integrally constructed from a single metal plate.
